(19) United States
(12) Patent Application Publication
(10) Pub. No.: US 2019/0226535 A1
(43) Pub. Date: Jul. 25, 2019

(54) CLUTCH DEVICE

(71) Applicant: JTEKT CORPORATION, Osaka-shi, Osaka (JP)

(72) Inventors: Hiroshi INUKAI, Ikoma-gun (JP); Ikuo YAMAMOTO, Kashiwara-shi (JP); Tomoya YAMATANI, Toyota-shi (JP); Masayo GODA, Osaka-shi (JP)

(73) Assignee: JTEKT CORPORATION, Osaka-shi, Osaka (JP)

(21) Appl. No.: 16/099,399

(22) PCT Filed: May 23, 2017
(86) PCT No.: PCT/JP2017/019108

§ 371 Date: Nov. 6, 2018

(30) Foreign Application Priority Data
May 23, 2016 (JP) 2016-102262
Sep. 27, 2016 (JP) 2016-188330

(51) Int. Cl. F16D 41/066; F16H 55/36; F16F 15/121; F16C 19/16; F16C 33/66

(52) U.S. Cl. CPC F16D 41/066; F16H 55/36; F16F 15/1216; F16D 2300/22; F16C 33/6659; F16H 2055/366; F16C 19/16

(57) ABSTRACT

A clutch device includes a shaft member, an outer rotor provided on a radially outer side of the shaft member, a clutch module configured to selectively switch between a free state where the shaft member and the outer rotor are allowed to rotate relatively and a lock state where the shaft member and the outer rotor are not allowed to rotate relatively, a coil spring configured to absorb a rotational fluctuation between the shaft member and the outer rotor in the lock state, and a bearing configured to support the shaft member and the outer rotor to rotate relatively is in the free state, and the clutch module is provided on the radially outer side of the shaft member, and the coil spring configured to absorb the rotational fluctuation is provided further radially outwards than the clutch module.

### TECHNICAL FIELD

The present invention relates to a clutch device.

### BACKGROUND ART

For example, an alternator, which is used as an auxiliary of an engine of a motor vehicle, is driven by a rotational force transmitted from a crankshaft of the engine. Namely, a pulley is attached to a rotational shaft of the alternator, and a belt is wrapped between this pulley and a pulley on the crankshaft, whereby the rotational force of the crankshaft is transmitted to the alternator by way of the belt.

A rotation speed of the crankshaft fluctuates because the rotational force of the crankshaft is based on explosion force generated in cylinders of the engine. When the rotation speed of the crankshaft fluctuates, the alternator cannot follow such a quick and drastic fluctuation in the rotation speed of the crankshaft, whereby a rotation speed difference temporarily occurs between the crankshaft and the alternator. The rotation speed difference causes a slip of the belt or applies an excessively great load to the belt, whereby the belt is caused to generate abnormal noise or the service life of the belt is reduced. Then, the pulley of the alternator is provided with a spring mechanism configured to absorb the rotation speed difference as well as a clutch module configured to engage or disengage the transmission of the rotational force of the crankshaft (refer to, for example, Patent Document 1).

FIG. 12 shows a clutch device as the clutch device described above which includes the pulley, the clutch module and the spring mechanism. This clutch device 90 includes a shaft member 91 to be attached to the rotational shaft of the alternator (not shown), a cylindrical outer member 99 provided on a radially outer side of the shaft member 91 and having a pulley module 98, a clutch module 97, a coil spring 96 configured to absorb a rotational fluctuation between the shaft member 91 and the outer member 99, and bearing modules 95, 94 configured to support the shaft member 91 and the outer member 99 so as to rotate relatively.

The bearing module 95 disposed at one axial side (a right side in FIG. 12) is a rolling bearing and has an outer ring 95a that fits in the outer member 99, an inner ring 95b that fits on the shaft member 91, a plurality of balls 95c and a cage 95d that holds the balls 95c. In contrast with the bearing module 95, the bearing module 94 disposed at the other axial side (a left side in FIG. 12) is a slide bearing and is provided between a spring seat 92 that is integrated with the shaft member 91 and the outer member 99. This bearing module 94 is made up, for example, of a resin bush 93, and an outer circumferential surface of this resin bush 93 is brought into sliding contact with part of an inner circumferential surface of the outer member 99. A radial load acting on the pulley module 98 can be borne by these bearing modules 95, 94.

### PRIOR ART DOCUMENT

### Patent Document

[Patent Document 1] JP-A-2015-025483

In the clutch device of Patent Document 1, the coil spring 96 that the clutch device 90 possesses can absorb the rotation speed difference (the rotational fluctuation) between the shaft member 91 and the outer member 99. However, unless the coil spring 96 functions sufficiently, the belt is caused to slip at the pulley module 98, and a great load is exerted on the belt and the constituent members and modules of the clutch device 90. Additionally, when a phenomenon like this occurs frequently, the constituent members and modules of the clutch device 90 get worn and damaged, resulting in a possibility that the product life of the clutch device 90 is reduced.

### SUMMARY OF THE INVENTION

According to an embodiment of the invention, a long life of a clutch device is realized.

According to an embodiment of the invention, there is provided a clutch device including a shaft member, an outer rotor provided on the radially outer side of the shaft member, a clutch module configured to selectively switch between a free state where the shaft member and the outer rotor are allowed to rotate relatively and a lock state where the shaft member and the outer rotor are not allowed to rotate relatively, a coil spring configured to absorb a rotational fluctuation between the shaft member and the outer rotor in the lock state, and a bearing configured to support the shaft member and the outer rotor to rotate relatively in the free state, wherein the clutch module is provided on the radially outer side of the shaft member, and the coil spring configured to absorb the rotational fluctuation is provided further radially outwards than the clutch module.

According to this clutch device, a diameter of the coil spring is increased, and a spring rate of the coil spring can be increased. This increases the rotational fluctuation absorbing characteristics of the clutch device, and even though, for example, a quick and drastic rotational fluctuation is generated between the shaft member and the outer rotor, the quick and drastic rotational fluctuation can be absorbed by the coil spring, thereby making it possible to prevent an exertion of a great load on the constituent elements of the clutch device. As a result, this leads to a long life of the clutch device.

According to the embodiment of the invention, the clutch device preferably includes a rolling bearing and a slide bearing as the bearing, and the slide bearing preferably has, between a part of the shaft member and a part of the outer rotor, a first bush module provided at one axial side and a second bush module provided at the other axial side while forming a grease holding space between the first bush module and the second bush module.

According to this construction, the space is defined between the first bush module and the second bush module of the slide bearing between the part of the shaft member and the part of the outer rotor, and grease can be reserved and held in this space. The shaft member and the outer rotor are supported by the rolling bearing and the slide bearing in the free state where the shaft member and the outer rotor are allowed to rotate relatively, and the grease in the space in the slide bearing can ensure a good lubricating ability over a long period of time.

According to the embodiment of the invention, the outer rotor may have a first spring seat provided on the radially outer side of the shaft member via the clutch module, a cylindrical outer member provided on a radially outer side of the first spring seat, and a second spring seat provided away from the first spring seat in an axial direction and configured to rotate together with the outer member, the coil spring may be attached to the first spring seat at one end portion of the coil spring and may be attached to the second spring seat at the other end portion of the coil spring, the clutch module may haves a function to switch between a free state where the shaft member and the first spring seat are allowed to rotate relatively and a lock state where the shaft member and the first spring seat are not allowed to rotate relatively, and the first bush module and the second bush module maybe provided between an inner circumferential surface of the second spring seat and an outer circumferential surface of the shaft member.

According to this configuration, the clutch device includes the shaft member, the outer rotor having the first spring seat provided on the radially outer side of the shaft member, the cylindrical outer member provided on the radially outer side of the first spring seat, and the second spring seat provided away from the first spring seat in the axial direction and configured to rotate together with the outer member, the clutch module configured to selectively switch between the free state where the shaft member and the first spring seat are allowed to rotate relatively and the lock state where the shaft member and the first spring seat are not allowed to rotate relatively, the coil spring attached to the first spring seat at the one end portion of the coil spring and attached to the second spring seat at the other end portion of the coil spring and configured to absorb the rotational fluctuation between the first spring seat that rotates together with the shaft member and the second spring seat in the lock state, the rolling bearing configured to support the shaft member and the outer member so as to rotate relatively in the free state, and the slide bearing configured to support the shaft member and the second spring seat so as to rotate relatively in the free state.

Then, the slide bearing includes, between the outer circumferential surface of the shaft member and the inner circumferential surface of the second spring seat, the first bush module provided at the axial side and the second bush module provided at the other axial side while forming the grease holding space between the first bush module and the second bush module.

By adopting this configuration, the good lubricating ability can be ensured over a long period of time by the grease in the space in the slide bearing.

According to the embodiment of the invention, it is preferable that the first bush module and the second bush module fit in an inner circumferential side of the second spring seat, that a convex portion and a concave portion are provided between an outer circumferential surface of the first bush module and the inner circumferential surface of the second spring seat, the convex portion and the concave portion being configured to fit each other so as to prevent an axial movement of the first bush module relative to the second spring seat, and that a convex portion and a concave portion are provided between an outer circumferential surface of the second bush module and the inner circumferential surface of the second spring seat, the convex portion and the concave portion being configured to fit each other so as to prevent an axial movement of the second bush module relative to the second spring seat.

According to this configuration, the outer circumferential surfaces of the first bush module and the second bush module constitute fitting surfaces that fit in the second spring seat, and the bush modules can be prevented from being dislocated from the second spring seat by the convex portion and the concave portion.

According to the embodiment of the invention, a cut-out portion is preferably provided on at least one bush module of the first bush module and the second bush module to expand the space formed between the other bush module and the at least one bush module.

According to this configuration, the area where to reserve the grease can be increased, and the good lubricating ability can be ensured over a longer period of time.

According to the embodiment of the invention, the slide bearing preferably has further a connecting bush module interposed between the first bush module and the second bush module to integrate the first bush module and the second bush module.

According to this configuration, since the first bush module and the second bush module are integrated together into one unit, an assembling operation of the slide bearing into the clutch device is facilitated.

According to the embodiment of the invention, the connecting bush module may be made up of a plurality of pillar modules provided at certain intervals in a circumferential direction and configured to connect together the first bush module having an annular shape and the second bush module having an annular shape.

In this case, spaces defined by the first bush module and the second bush module and the pillar modules disposed adjacent to one another in the circumferential direction constitute the grease holding space.

According to an embodiment of the invention, the connecting bush module may have an annular third bush module provided between the first bush module having the annular shape and the second bush module having the annular shape and a pillar module configured to connect together the bush modules disposed adjacent to each other in an axial direction.

In this case, a space defined between the first bush module and the third bush module constitutes the grease holding space, and a space defined between the second bush module and the third bush module constitute the grease holding space. The third bush module should be provided singularly or in plural. When a plurality of third bush modules are provided, these third bush modules are also connected together by a pillar module, and a space defined by these third bush modules also constitutes the grease holding space.

According to another embodiment of the invention, there is provided a clutch device including a shaft member, an outer rotor provided on a radially outer side of the shaft member, a clutch module configured to selectively switch between a free state where the shaft member and the outer rotor are allowed to rotate relatively and a lock state where the shaft member and the outer rotor are not allowed to rotate relatively, a coil spring configured to absorb a rotational fluctuation between the shaft member and the outer rotor in the lock state, and a rolling bearing and a slide bearing, the rolling bearing and the slide bearing being configured to support the shaft member and the outer rotor to rotate relatively in the free state, wherein the slide bearing includes, between a part of the shaft member and a part of the outer rotor, a first bush module provided at one axial side and a second bush module provided at the other axial side while forming a grease holding space between the first bush module and the second bush module.

According to this clutch device, the space is defined by the first bush module and the second bush module of the slide bearing between the part of the shaft member and the part of the outer rotor, and grease can be reserved and held in this space. The shaft member and the outer rotor are supported by the rolling bearing and the slide bearing in the free state where the shaft member and the outer rotor are allowed to rotate relatively, and grease reserved and held in this space can ensure the good lubricating ability over a long period of time. As a result, the configuration can contribute to realization of a long life of the clutch device.

### ADVANTAGEOUS EFFECT

A long life of the clutch device can be realized.

### BRIEF DESCRIPTION OF DRAWINGS

FIG. 1 is a sectional view showing an embodiment of a clutch device of the invention.

FIG. 2 is a sectional view resulting when a clutch module is seen in an axial direction.

FIG. 3 is a sectional view showing a slide bearing and a periphery of the slide bearing.

FIG. 4 is a sectional view showing bush modules according to a modified example.

FIG. 5 is a sectional view showing bush modules according to another modified example.

FIG. 6 is a sectional view showing bush modules according to a further modified example.

FIG. 7 is a sectional view showing bush modules according to a modified example.

FIG. 8 is a perspective view showing a slide bearing of another embodiment,

FIG. 9 is a perspective view showing a slide bearing according to a modified example made to the slide bearing shown in FIG. 8.

FIG. 10 is a perspective view showing a slide bearing of a further embodiment.

FIG. 11 is a perspective view showing a slide bearing according to a modified example made to the slide bearing shown in FIG. 10.

FIG. 12 is a sectional view of a conventional clutch device.

FIG. 13 is a perspective view of a bush.

### MODE FOR CARRYING OUT THE INVENTION

Hereinafter, embodiments of the invention will be described by reference to drawings.

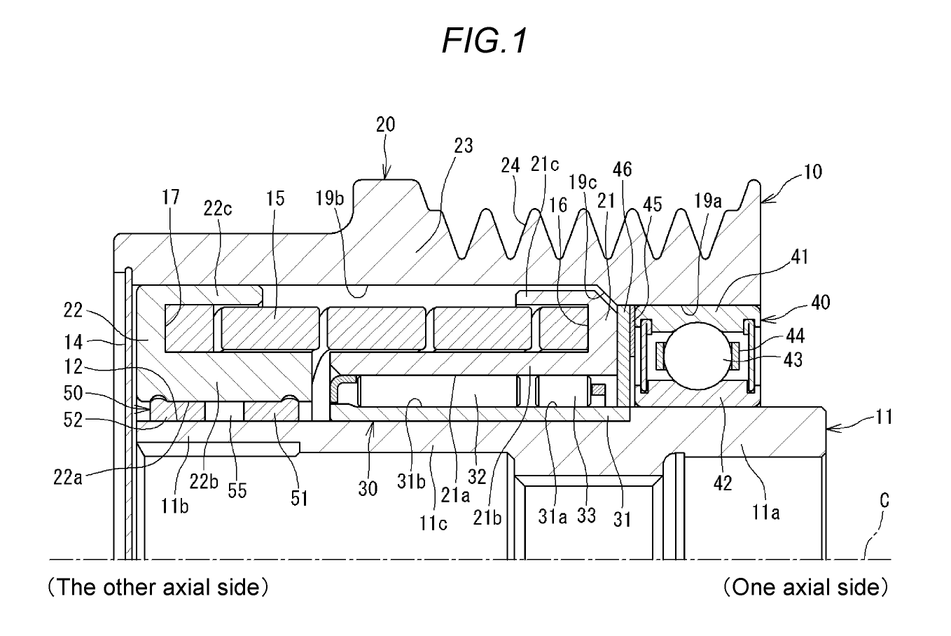

FIG. 1 is a sectional view showing an embodiment of a clutch device of the invention. A clutch device 10 of this embodiment is attached to a rotational shaft of an alternator, not shown. The clutch device 10 includes a shaft member 11, an outer rotor 20, a clutch module 30, a coil spring 15, a rolling bearing 40 and a slide bearing 50.

The shaft member 11 is a cylindrical member and is coupled to the rotational shaft of the alternator on an inner circumferential side of the shaft member 11. The shaft member 11 has a first cylindrical portion 11a at one axial side (a right side in FIG. 1), a second cylindrical portion 11b at the other axial side (a left side in FIG. 1) and a third cylindrical portion 11c at a center in an axial direction. The rolling bearing 40 is attached to the first cylindrical portion 11a so as to fit on it. The slide bearing 50 fits on the second cylindrical portion 11b through a clearance fit, and the slide bearing 50 is brought into sliding contact with an outer circumferential surface 12 of the second cylindrical portion 11b. An inner ring member 31 of the clutch module 30 is attached to the third cylindrical portion 11c so as to fit on it, and the rolling bearing 40, the slide bearing 50 and the inner ring member 31 rotate together.

The outer rotor 20 includes an outer member 23, a first spring seat 21 and a second spring seat 22. The outer member 23 is a cylindrical member and has a pulley module 24 at one axial side of an outer circumference of the outer member 23, and a belt, not shown, is wrapped around the pulley module 24.

The first spring seat 21 is a cylindrical member and is provided on the radially outer side of the shaft member 11 via the clutch module 30. The outer member 23 is provided on the radially outer side of the first spring seat 21, and a gap is formed between the first spring seat 21 and the outer member 23. An inner circumferential surface 21a of the first spring 21 is formed into a cylindrical surface centered at an axis C of the clutch device 10. Cylindrical rollers 33 of the clutch module 30, which will be described later, are brought into rolling contact with one axial side of the inner circumferential surface 21a. Additionally, needle rollers 32 of the clutch module 30, which will be described later, move towards for contact and away from the other axial side of the inner circumferential surface 21a of the first spring seat 21.

The second spring seat 22 is a cylindrical member and is attached to an inner circumferential side of the outer member 23 so as to fit in it, whereby the second spring seat 22 and the outer member 23 rotate together. The second spring seat 22 is provided away from the first spring seat 21 in an axial direction. A circumferential surface 22a of the second spring seat 22 is made up of a cylindrical surface centered at the axis C, and the slide bearing 50 is attached to the inner circumferential surface 22a through an interference fit.

The coil spring 15 is attached between the first spring seat 21 and the second spring seat 22. One end portion 16 of the coil spring 15 is fixed to the first spring seat 21, and the other end portion 17 is fixed to the second spring seat 22. This enables the outer member 23, the second spring seat 22, the coil spring 15 and the first spring seat 21 to rotate together. Although it will be described later, with the clutch module 30 switching to a lock state where the shaft member 11, the inner ring member 31 and the first spring seat 21 can rotate together, when a rotational fluctuation (a rotation speed difference) is generated between the shaft member 11 and the outer member 23, the coil spring 15 can absorb this rotational fluctuation (the rotation speed difference).

The clutch module 30 has the inner ring member 31 and the plurality of rollers (needle rollers) 32. The clutch module 30 also has the plurality of cylindrical rollers 33. The inner ring member 31 rotates together with the shaft member 11. An outer circumferential surface of the inner ring member 31 has a raceway surface 31a at one axial side and a cam surface 31b at the other axial side. The raceway surface 31a is made up of a cylindrical surface centered at the axis C, and the plurality of cylindrical rollers 33 are brought into rolling contact with the raceway surface 31a. The cylindrical rollers 33 are held at certain intervals in a circumferential direction by an annular cage, not shown, and support the inner ring member 31 and the first spring seat 21 in a concentric fashion while bearing a radial load exerted on the first spring seat 21.

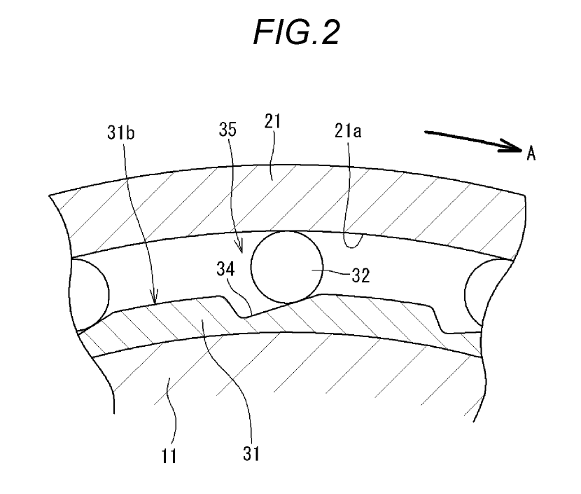

As FIG. 2 shows, a plurality of recessed portions 34 are provided on the cam surface 31b of the inner ring member 31, and wedge spaces 35 are formed between the recessed portions 34 and the inner circumferential surface 21a of the first spring seat 21. One needle roller 32 is provided in each of the wedge spaces 35. Although not shown, a spring is provided which biases the needle rollers 32 in a direction in which the wedge spaces 35 get narrow.

With the clutch module 30 configured in the way described above, when the second spring seat 22, the coil spring 15 and the first spring seat 21 rotate together with the outer member 23 in a clockwise direction (a direction indicated by an arrow A) in FIG. 2 relative to the inner ring member 31 and the shaft member 11 with the outer member 23 having the pulley module 24 (refer to FIG. 1) rotating at a constant or increasing speed, the needle rollers 32 bite into areas on narrow sides of the wedge spaces 35 to thereby be brought into frictional engagement with the recessed portions 34 and the inner circumferential surface 21a, whereby the clutch module 30 switches to the lock state. Namely, the clutch module 30 switches to a lock state where the shaft member 11 and the inner ring member 31 are not allowed to rotate relatively to the first spring seat 21 (that is, a lock state where the shaft member 11 and the inner ring member 31 are allowed to rotate together with the first spring seat 21). As has been described above, the shaft member 11 and the outer member 23 are allowed to rotate together in the lock state because the outer member 23, the second spring seat 22, the coil spring 15 and the first spring seat 21 are configured to rotate together.

On the contrary, when the outer member 23 having the pulley module 24 (refer to FIG. 1) comes to rotate at a decreasing speed, the inner ring member 31 and the shaft member 11 rotate at higher speeds than the outer rotor 20 (the outer member 23, the first spring seat 21 and the like). As this occurs, in FIG. 2, the needle rollers 32 withdraw into areas on wider sides of the wedge spaces 35 (against the spring), and the frictional engagement is released, whereby the clutch 30 switches to a free state. Namely, the clutch module 30 switches to a free state where the shaft member 11 and the inner ring member 31 are allowed to rotate relatively to the first spring seat 21. As a result, the shaft member 11 and the outer member 23 are allowed to rotate relatively in the free state.

Thus, the clutch module 30 can switch selectively between the lock state and the free state according to the rotation speed of the outer member 23 relative to the shaft member 11.

In FIG. 1, as has been described above, the coil spring 15 is attached to the first spring seat 21 at the one end portion 16 of the coil spring 15 and is attached to the second spring seat 22 at the other end portion 17 of the coil spring 15. Due to this, the coil spring 15 has a function to absorb a rotational fluctuation between the first spring seat 21 that rotates together with the shaft member 11 and the second spring seat 22, when the clutch module 30 switches to the lock state. Namely, the rotational fluctuation generated between the shaft member 11 and the outer member 23 can be absorbed by the coil spring 15.

Then, as FIG. 1 shows, the clutch module 30 is provided on the radially outer side of the shaft member 11, and the coil spring 15, which is configured to absorb a rotational fluctuation, is provided further radially outwards than the clutch module 30. This increases a diameter of the coil spring 15 is increased, and a spring rate of the coil spring 15 can be increased. This increases the rotational fluctuation absorbing characteristics of the clutch device 10, and even though, for example, a quick and drastic rotational fluctuation is generated between the shaft member 11 and the outer rotor 20, the quick and drastic rotational fluctuation can be absorbed by the coil spring 15, thereby making it possible to prevent an exertion of a great load on the constituent elements of the clutch device 10. As a result, this leads to a long life of the clutch device 10. In addition, in this embodiment, a wire material making up the coil spring 15 has a rectangular section which is longer axially than radially. This makes the clutch device 10 compact in a radial direction.

The rolling bearing 40 has an outer ring 41 that fits in the outer member 23, an inner ring 42 that fits on the shaft member 11, a plurality of balls (rolling elements) 43 and a cage 44 configured to hold these balls 43. The outer ring 41 is fixed to the outer member 23. A washer 45 and a thrust bush 46 are interposed between the outer ring 41 and the first spring seat 21, and the outer ring 41 can bear a thrust load of the first spring seat 21 via the washer 45 and the thrust bush 46. The thrust load of the first spring seat 21 depends on an elastic force of the coil spring 15. Thus, the rolling bearing 40 is attached between the shaft member 11 and the outer member 23 and can support the shaft member 11 and the outer member 23 so as to rotate relatively when the clutch module 30 is in the free state.

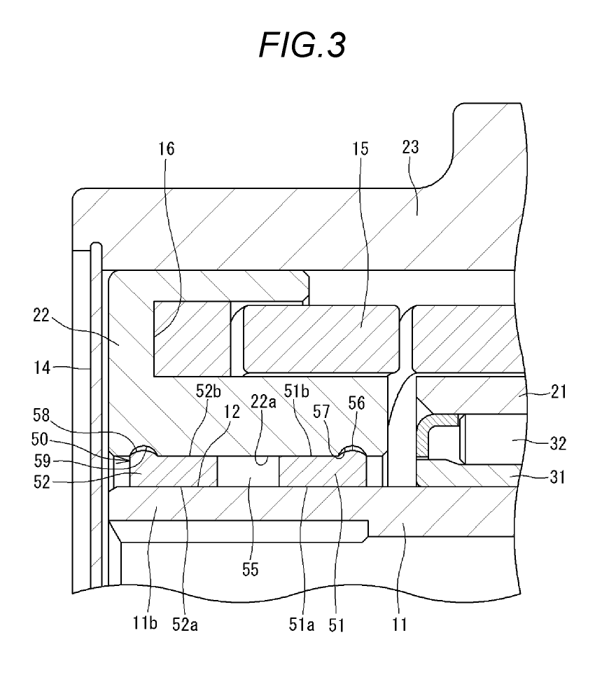

FIG. 3 is a sectional view showing the slide bearing 50 and a periphery of the slide bearing 50. The slide bearing 50 has a first bush module 51 provided at one axial side and a second bush module 52 provided at the other axial side. The first bush module 51 and the second bush module 52 are provided away from each other in the axial direction between an outer circumferential surface 12 of the shaft member 11 and an inner circumferential surface 22a of the second spring seat 22, and a grease holding space 55 is defined between the first bush module 51 and the second bush module 52. The first bush module 51 and the second bush module 52 are both annular members and are formed of resin (for example, PTFE) in this embodiment. The first bush module 51 fits in the second spring seat 22 with an interference provided therebetween, and the second bush module 52 is fit in the second spring seat 22 with an interference provided therebetween. Namely, the bush modules 51 52 are interference fitted in the second spring seat 22.

A fine gap is defined between an inner circumferential surface 51a of the first bush module 51 and the outer circumferential surface 12 of the shaft member 11. Additionally, the fine gap is defined between an inner circumferential surface 52a of the second bush module and an outer circumferential surface 12 of the shaft member 11. Namely, the bush modules 51, 52 are clearance fitted on the shaft member 11 and are both brought into sliding contact with the shaft member 11. Thus, the slide bearing 50 is attached between the shaft member 11 and the second spring seat 22 and can support the second spring seat 22 and the outer member 23 so as to rotate relatively to the shaft member 11 in the free state.

Thus, as has been described heretofore, the clutch device 10 shown in FIG. 1 includes the shaft member 11 and the outer rotor 20 provided on the radially outer side of the shaft member 11. The outer rotor 20 includes the first spring seat 21 provided on the radially outer side of the shaft member 11 via the clutch module 30, the cylindrical outer member 23 provided on the radially outer side of the first spring seat 21, and the second spring member 22 disposed away from the first spring seat 21 in the axial direction and configured to rotate together with the outer member 23.

Additionally, the clutch device 10 includes the clutch module 30, and this clutch module 30 can selectively switch between the free state where the shaft member 11 and the outer rotor 20 (the first spring seat 21) are allowed to rotate relatively and the lock state where the shaft member 11 and the outer rotor 20 (the first spring seat 21) are not allowed to rotate relatively.

Further, the clutch device 10 includes the coil spring 15 that is attached to the first spring seat 21 at the one end portion 16 of the coil spring 15 and is attached to the second spring seat 22 at the other end portion 17 of the coil spring 15. The coil spring 15 can absorb a rotational fluctuation between the shaft member 11 and the outer rotor 20 when the clutch module 30 is in the lock state.

Then, the clutch device 10 includes the rolling bearing 40 and the slide bearing 50 both configured to support the shaft member 11 and the outer rotor 20 so as to rotate relatively when the clutch module 30 is in the free state, and a radial load exerted on the pulley module 24 of the outer member 23 can be borne by the rolling bearing 40 and the slide bearing 50. Additionally, the slide bearing 50 is provided as a bearing module at the other axial side, whereby the bearing module can be disposed on a radially inner side of the second spring seat 22, whereby the clutch device 10 can be made small in size.

Then, a cover 14 is attached to the other axial end portion of the outer member 23, that is, an end portion of the outer member 23 situated on the second spring seat 22, whereby an intrusion of foreign matters into the clutch device 10 is prevented.

The slide bearing 50 will be described further. In this embodiment, the first bush module 51 and the second bush module 52 are the same and both have a ring shape. As FIG. 3 shows, the first bush module 51 and the second bush module 52 are provided away from each other in the axial direction to thereby define the grease holding space 55 between the first bush module 51 and the second bush module 52, and the resulting space 55 constitutes an annular space (a space formed continuously in a circumferential direction). The bush modules 51, 52 are held by the second spring seat 22 and the shaft member 11, whereby the grease holding space 55 becomes an annular space that is covered from both sides in the axial direction and from both sides in a radial direction. Grease is loaded in the space 55 that is defined when the bush modules 51, 52 are assembled into the clutch device 10.

The bush modules 51, 52 both have the ring shape and are attached to the inner circumferential surface 22a of the second spring seat 22 so as to press fit in it by moving the bush modules 51, 52 towards the second spring seat 22 in the axial direction. This enables the bush modules 51, 52 to fit in the inner circumferential side of the second spring seat 22 with the interference provided between the inner circumferential side of the second spring seat 22 and themselves.

In this embodiment, a configuration is provided in which the bush modules 51, 52 attached to the second spring seat 22 through press fit are prevented from moving in the axial direction to be dislocated from the second spring seat 22. Namely, a convex portion 56 is provided on an outer circumferential surface 51b of the first bush module 51, and a concave portion 57, into which the convex portion 56 fits, is formed on the inner circumferential surface 22a of the second spring seat 22. Similarly, a convex portion 58 is provided on an outer circumferential surface 52b of the second bush module 52, and a concave portion 59, into which the convex portion 58 fits, is formed on the inner circumferential surface 22a of the second spring seat 22. In this way, the convex portion and the concave portion (56, 57) are provided between the outer circumferential surface 51b of the first bush module 51 and the inner circumferential surface 22a of the second spring seat 22. Then, the first bush module 51 is prevented from moving in the axial direction relative to the second spring seat 22 as a result of the convex portion and the concave portion (56, 57) fitting on and in each other. Additionally, the convex portion and the concave portion (58, 59) are provided between the outer circumferential surface 52b of the second bush module 52 and the inner circumferential surface 22a of the second spring seat 22. Then, the second bush module 52 is prevented from moving in the axial direction relative to the second spring seat 22 as a result of the convex portion and concave portion (58, 59) fitting on and in each other.

Thus, as has been described heretofore, the slide bearing 50 of the clutch device 10 of this embodiment has the first bush module 51 and the second bush module 52 between part (the second cylindrical portion 11b) of the shaft member 11 and part (the second spring seat 22) of the outer rotor 20. The first bush module 51 is provided at the axial side. The second bush module 52 is provided at the other axial side while defining the grease holding space 55 between the first bush module 51 and the second bush module. According to this clutch device 10, the shaft member 11 and the outer rotor 20 (the second spring seat 22) are supported by the rolling bearing 40 and the slide bearing 50 in the free state where the shaft member 11 and the outer rotor 20 (the second spring seat 22) are allowed to rotate relatively, and grease can be reserved and held in the space 55 in the slide bearing 50, whereby a good lubricating ability can be ensured over a long period of time by the grease in the space 55. As a result, the slide bearing 50 can contribute to realization of a long life of the clutch device 10.

In this embodiment, the fine gap is defined between the bush modules 51, 52 and the shaft member 11, and an oil film of grease is formed in this fine gap, and although heat would otherwise be generated as a result of the bush modules 51 52 being brought into sliding contact with the shaft member 11, the generation of heat can be suppressed by the oil film.

Outer circumferential sides of the bush modules 51 52 will be described. The bush modules 51, 52 are attached to the inner circumferential surface 22a of the second spring seat 22 on the outer circumferential surfaces 51b, 52b with the interference provided therebetween. This can prevent the grease from escaping between the second spring seat 22 and the bush modules 51, 52 even though the grease in the space 55 is caused to move radially outwards by a centrifugal force generated by the rotation of the shaft member 11.

Additionally, the bush modules 51, 52 are provided in the position lying closer to a radially inner side of the clutch device 10. Namely, the bush modules 51, 52 are provided on a shaft member 11 side of the clutch device 10. This can make a relative speed (a circumferential speed) between sliding contact surfaces (the inner circumferential surfaces 51a, 52a) of the bush modules 51, 52 and a mating member (the shaft member 11) relatively small and can make a PV value of the slide bearing 50 small. Although not shown, in the event that the bush modules 51, 52 are provided on a radially outer side of the clutch device 10, that is, on an outer member 23 side of the clutch device 10, the relative speed (the circumferential speed) to the mating member becomes great, increasing the PV value to a high level. However, in the embodiment, the PV value can be suppressed.

In the embodiment, the bush modules 51, 52 have a rectangular sectional shape (a rectangular rounded at corner portions). However, the bush modules 51, 52 may have other sectional shapes.

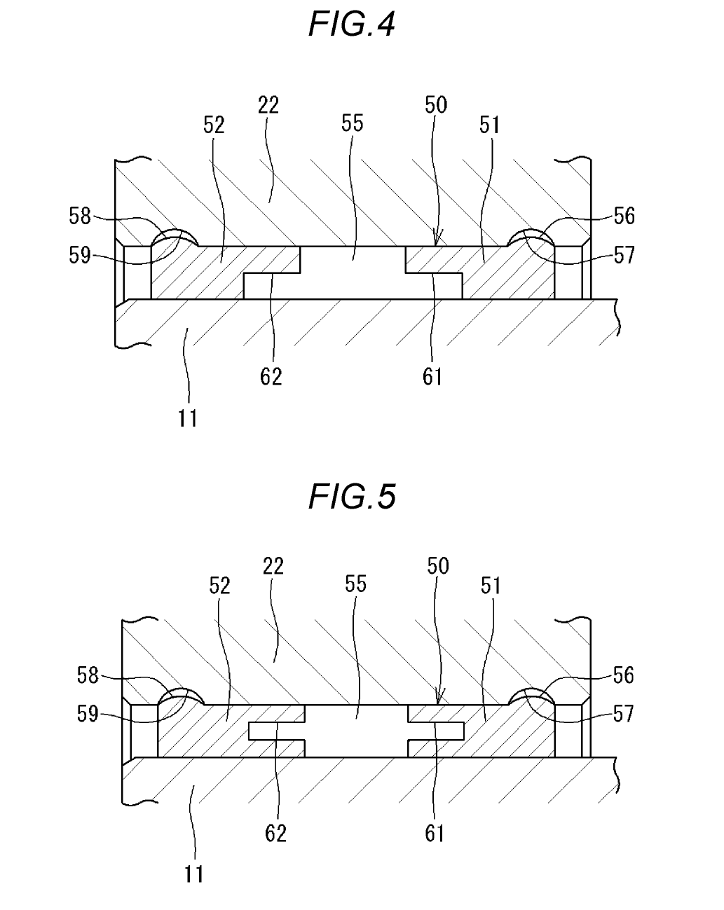

FIG. 4 is a sectional view showing bush modules 51, 52 (a slide bearing 50) according to a modified example. A cut-out portion 61 is provided at the other axial side of a first bush module 51 at one axial side. The cut-out portion 61 is provided on a radially inner side of the first bush module 51. A cut-out portion 62 is provided at one axial side of a second bush module 52 at the other axial side. The cut-out portion 62 is provided on a radially inner side of the second bush module 52. By adopting this configuration, a space 55 including the cut-out portions 61, 62 is defined between the first bush module 51 and the second bush module 52, and much grease can be reserved in this space 55.

FIG. 5 is a sectional view showing bush modules 51, 52 (a slide bearing 50) according to another modified example. In a form shown in FIG. 5, a cut-out portion 61 is provided at a radial center of a first bush module 51, and a cut-out portion 62 is provided at a radial center of a second bush module 52.

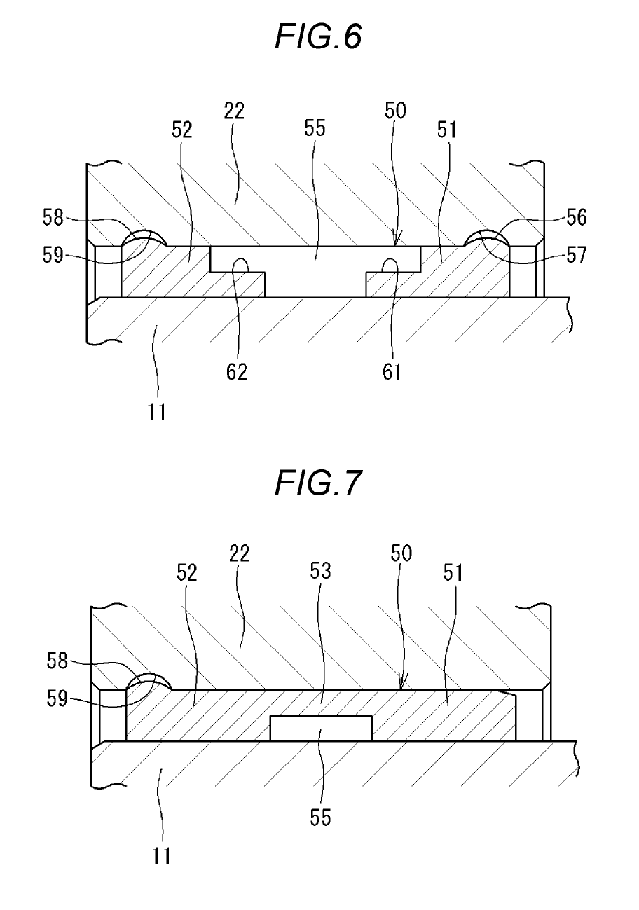

FIG. 6 is a sectional view showing bush modules 51, 52 (a slide bearing 50) according to a further modified example. In a form shown in FIG. 6, a cut-out portion 61 is provided on a radially outer side of a first bush module 51, and a cut-out portion 62 is provided on a radially outer side of a second bush module 52.

In these forms shown in FIGS. 5 and 6, too, a space 55 including the cut-out portions 61, 62 is formed between the first bush module 51 and the second bush module 52, and much grease can be reserved by the space 55.

In the forms shown in FIGS. 4, 5 and 6, the cut-out portions (61, 62) are described as being formed in both the first bush module 51 and the second bush module 52. However, such a cut-out portion may be provided only on either of a pair of bush modules 51, 52.

Thus, as has been described heretofore, in the forms shown in FIGS. 4, 5 and 6, the cut-out portion 61 (62) is provided on at least one bush module of the first bush module 51 and the second bush module 52 to expand the space 55 defined between the other bush module and the second bush module. According to the slide bearing 50 made up of these bush modules 51, 52, the area where to reserve grease can be increased, whereby a good lubricating ability can be ensured over a longer period of time by the grease.

FIG. 7 is a sectional view showing bush modules 51, 52 (a slide bearing 50) according to a modified example. Although the first bush module 51 and the second bush module 52 are the separate members in the forms described heretofore, in a form shown in FIG. 7, a first bush module 51 and a second bush module 52 are connected together to be integrated into one unit. Namely, a slide bearing 50 has the first bush module 51 that is brought into sliding contact with a shaft member 11, the second bush module 52 that is brought into sliding contact with the shaft member 11 and a cylindrical connecting module 53 that connects the first bush module 51 and the second bush module 52 together while being kept in non-contact with the shaft member 11. In this case, too, a grease holding space 55 is defined between the first bush module 51 and the second bush module 52 and on a radially inner side of the connecting module 53. With the form shown in FIG. 7, the number of parts involved can be reduced, and an attaching operation of the slide bearing 50 to a second spring seat 20 is facilitated. Namely, in the slide bearing 50 shown in FIG. 7, the cylindrical connecting module 53 as the connecting bush module is interposed between the first bush module 51 and the second bush module 52, and this connecting module 53 integrates the first bush module 51 and the second bush module 52.

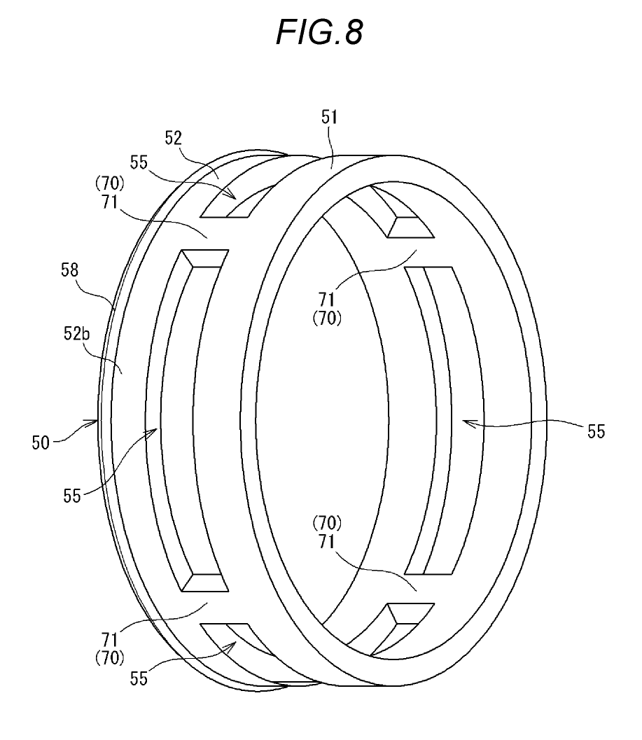

FIG. 8 is a perspective view showing a slide bearing 50 of another embodiment. This slide bearing 50 is the same as the slide bearing 50 shown in FIG. 3 in that the slide bearing 50 has a first bush module 51 and a second bush module 52. In addition, the slide bearing 50 has further a connecting bush module 70 that is interposed between the bush modules 51, 52. The connecting bush module 70 shown in FIG. 8 is made up of a plurality of pillar modules 71 provided at certain intervals in a circumferential direction and connects partially the first bush module 51 having an annular shape and the second bush module 52 having an annular shape. In the case of this slide bearing 50, spaces defied by the first bush module 51 and the second bush module 52 and the pillar modules 71, 71 that lie adjacent to one another in the circumferential direction constitute a grease holding space 55. The space 55 is divided by the pillar modules 71.

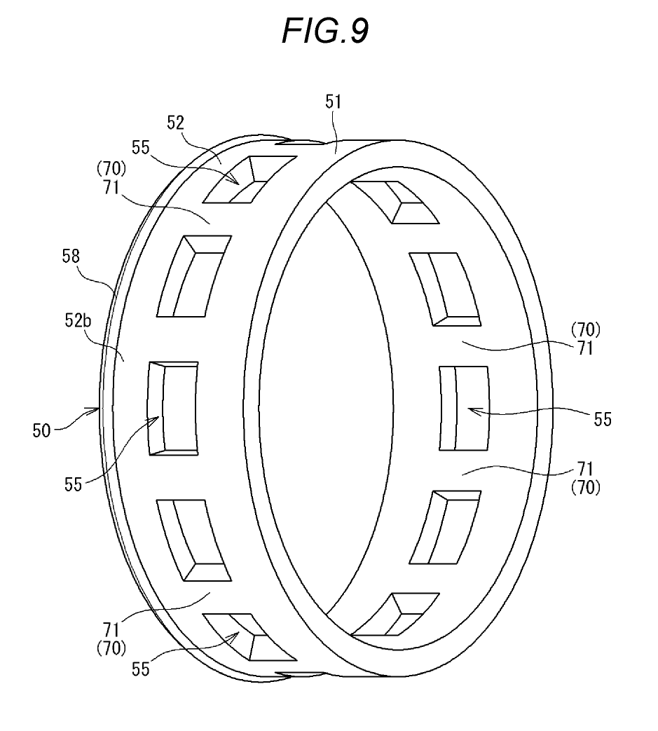

FIG. 9 is a perspective view showing a slide bearing 50 according to a modified example made to the slide bearing 50 shown in FIG. 8. When comparing this slide bearing 50 with the slide bearing 50 shown in FIG. 8, the slide bearing 50 shown in FIG. 9 has a greater number of pillar modules 71 but remains the same in the other configurations. Spaces defined by a first bush module 51 and a second bush module 52 and by pillar modules 71 that lie adjacent to one another in a circumferential direction constitute a grease holding space 55. In the form shown in FIG. 9, respective dimensions of the first bush module 51, the second bush module 52 and the pillar modules 71 are set so that the volume (in total) of the spaces 55 becomes equal to that of the spaces 55 defined in the form shown in FIG. 8.

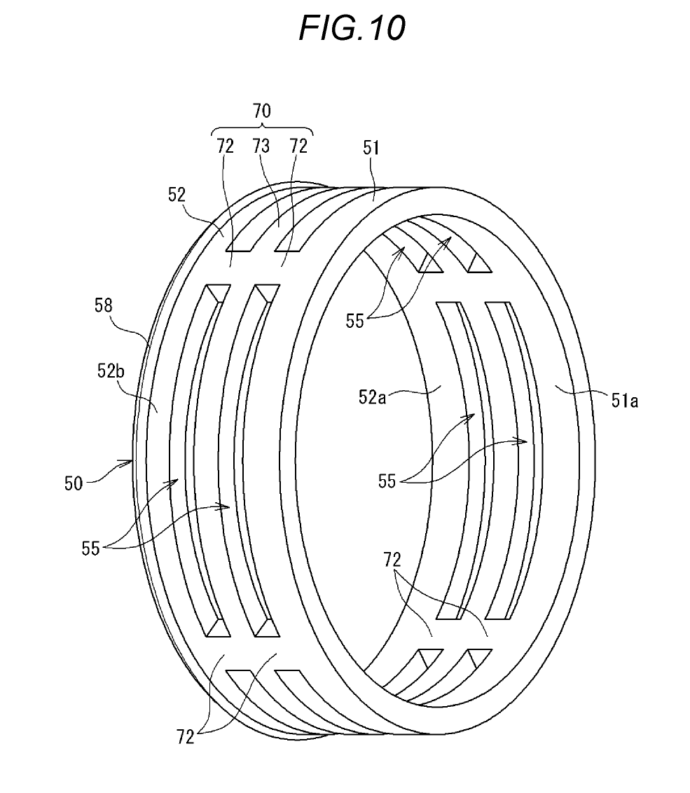

FIG. 10 is a perspective view showing a slide bearing 50 according to a further embodiment. This slide bearing 50 is the same as the slide bearing 50 shown in FIG. 3 in that the slide bearing 50 has a first bush module 51 and a second bush module 52 but has further a connecting bush module 70 interposed between the bush modules 51, 52. The connecting bush module 70 of the form shown in FIG. 10 has an annular third bush module 73 and a plurality of pillar modules 72. The third bush module 73 is provided between the first bush module 51 having an annular shape and the second bush module 52 having an annular shape. The individual pillar modules 72 connect the first bush module 51 and the third bush module 73 together and also connect the third bush module 73 and the second bush module 52 together. Namely, the pillar modules 72 connect the bush modules lying adjacent to one another in an axial direction. The plurality of pillar modules 72 are provided at certain intervals (equal intervals) in a circumferential direction. In the case of this slide bearing 50, spaces defined by the first bush module 51 and the third bush module 73 and the pillar modules 71, 71 lying adjacent to one another in the circumferential direction constitute a grease holding space 55, and spaces defined by the second bush module 52 and the third bush module 73 and the pillar modules 71, 71 lying adjacent to one another in the circumferential direction constitute a grease holding space 55.

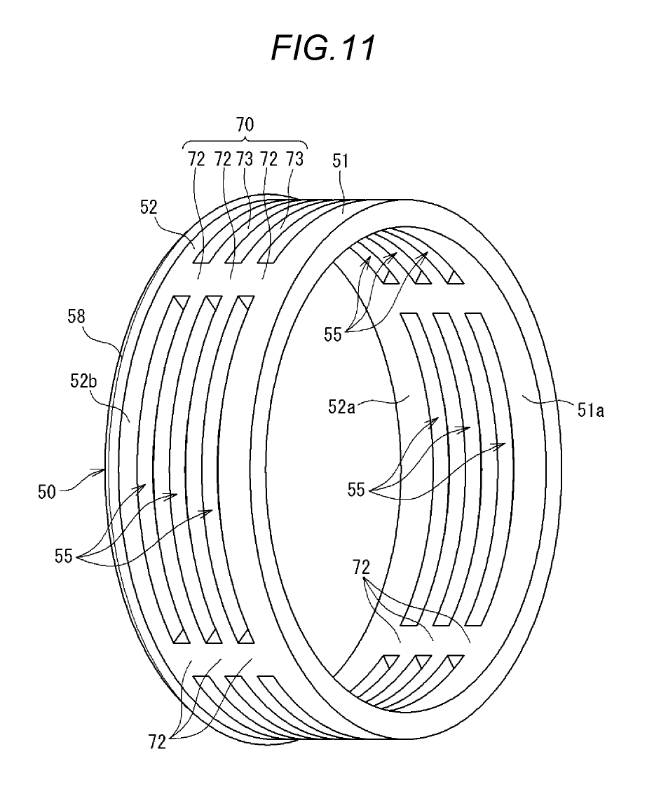

FIG. 11 is a perspective view showing a slide bearing 50 according to a modified example made to the slide bearing 50 shown in FIG. 10. When comparing this slide bearing 50 with the slide bearing 50 shown in FIG. 10, the slide bearing 50 shown in FIG. 11 has a plurality of (two) third bush modules 73. At least one third bush module 73 should be provided between a first bush module 51 and a second bush module 52. Then, these bush modules are connected to one another by pillar portions 72.

In the case of the slide bearing 50 shown in FIG. 11, spaces defined by the first bush module 51 and the third bush module 73 and by the pillar portions 72, 72 that lie adjacent to one another in a circumferential direction constitute a grease holding space 55. Additionally, spaces defined by the second bush module 52 and the third bush module 73 and the pillar portions 72, 72 that lie adjacent to one another in the circumferential direction constitute a grease holding space 55. Further, spaces defined by the third bush modules 73, 73 that lie adjacent to each other and the pillar portions 72, 72 that lie adjacent to one another in the circumferential direction constitute a grease holding space 55.

In the forms shown in FIGS. 10 and 11, too, respective dimensions of the first bush module 51, the second bush module 52, the third bush modules 73 and the pillar portions 72 are set so that the volume (in total) of the spaces 55 becomes equal to that of the spaces defined in the form shown in FIG. 8.

As FIGS. 8, 9, 10 and 11 show individually, the slide bearing 50 has, in addition to the first bush module 51 and the second bush module 52, the connecting bush module 70 interposed between the first bush module 51 and the second bush module 52, and this connecting bush module 70 integrates the first bush module 51 and the second bush module 52. An assembling operation of the slide bearing 50 into the clutch device 10 is facilitated because the first bush module 51 and the second bush module 52 are integrated.

In the embodiments and their modified examples that have been described above, the first bush module 51, the second bush module 52 and the connecting bush module 70 have the same thickness (radial dimension). Due to this, the connecting bush module 70 also interference fit in the second spring seat 22, and the connecting bush module 70 is also brought into sliding contact with the shaft member 11 on an inner circumferential surface of the connecting bush module 70. In this way, since the connecting bush module 70 is also brought into contact with the shaft member 11 and the second spring seat 22, the contact area is expanded, whereby the contact surface pressure on the slide bearing 50 can be reduced.

In addition, in the embodiments and their modified examples that have been described above, a convex portion 58 is provided on an outer circumferential surface 52b of the second bush module 52. This convex portion 58 is the same as the convex portion 58 of the embodiment shown in FIG. 3. This convex portion 58 fits in a concave portion 59 formed on an inner circumferential surface 22a of the second spring seat 22, whereby the slide bearing 50, which is attached to the second spring seat 22 so as to fit in it, can be prevented from moving in an axial direction to be dislocated from the second spring seat 22. The convex portion 58 should be provided only on either of the first bush module 51 and the second bush module 52 because the first bush module 51 and the second bush module 52 are integrated. The convex portion 58 is preferably provided on the second bush module 52 that is situated on an axially outer side of the slide bearing 50 from the viewpoint of preventing a leakage of grease.

Although not shown, a groove or a hole may be formed on the pillar portion 71 (72) along a circumferential direction so as to allow the circumferentially adjacent spaces 55, 55 to communicate with each other byway of the groove or the hole formed. As this occurs, grease is allowed to move between the spaces 55, 55.

In addition, in the case of the embodiment and its modified example shown in FIGS. 10 and 11, although not shown, a groove or a hole may be formed on the third bush module 73 along an axial direction parallel to a center axis of the slide bearing 50 so as to allow the axially adjacent spaces 55, 55 to communicate with each other byway of the groove or the hole formed. As this occurs, grease is allowed to move between the spaces 55, 55.

Additionally, the pillar portion 71 (72) is formed into the shape of a straight line extending along the axial direction parallel to the center axis of the slide bearing 50, however, the pillar portion 71 (72) may be formed into the shape of a straight line extending in a direction oblique to the axial direction. Although the space 55 is formed into a straight shape along the circumferential direction, the space 55 may be formed into a circumferentially oblique shape.

The constituent elements of the clutch device 10 will be described in detail.

As FIG. 1 shows, the first spring seat 21 has an inner cylindrical portion 21b situated on a radially inner side of the coil spring 15 and an outer cylindrical portion 21c situated on a radially outer side of the coil spring 15. In such a state that no rotation speed difference is generated between the shaft member 11 and the outer rotor 20 (refer to FIG. 1), a gap is generated between an outer circumferential surface of the coil spring 15 and an inner circumferential surface of the outer cylindrical portion 21c. Then, when the rotation speed difference is generated to exert a torsional force on the coil spring 15, whereby the coil spring 15 is elastically deformed in a direction in which the diameter of the coil spring 15 is expanded, the outer circumferential surface of the coil spring 15 is brought into contact with the inner circumferential surface of the outer cylindrical portion 21c. When the coil spring 15 is brought into contact with the outer cylindrical portion 21c in the way described above, one axial side of the coil spring 15 can be deformed (twisted) along the circumferential direction while being guided by the outer cylindrical portion 21c. In the event that the outer cylindrical portion 21c is not provided, when the coil spring 15 is elastically deformed, the axial side of the coil spring 15 is deformed freely, leading to fears that bending stress is generated locally. In the embodiment, however, since the outer cylindrical portion 21c guides the deformation of the coil spring 15, the generation of such bending stress can be prevented, thereby the deformation of the coil spring 15 can be suppressed. The inner cylindrical portion 21b of the first spring seat 21 not only functions to guide a deformation of the coil spring 15 but also functions as an outer ring member into which the needle rollers 32 of the clutch module 30 bite when the coil spring 15 is elastically deformed so as to be contracted diametrically. In addition, the second spring seat 22 also has an inner cylindrical portion 22b and an outer cylindrical portion 22c and has the same functions as those of the first spring seat 21.

The outer member 23 is a cylindrical member and has, on an inner circumference thereof, an inner circumferential surface 19a of a small diameter, an inner circumferential surface 19b of a large diameter and a tapering surface that connects the inner circumferential surfaces 19a, 19b together. The outer ring 41 of the rolling bearing 40 is attached to the small diameter inner circumferential surface 19a so as to fit in it. The first spring seat 21, the second spring seat 22 and the coil spring 15 are disposed on a radially inner side of the large diameter inner circumferential surface 19b. Additionally, as has been described above, the washer 45 and the thrust bush 46 are interposed between the outer ring 41 and the first spring seat 21, and the washer 45 and the thrust bush 46 are provided on a radially inner side of the small diameter inner circumferential surface 19a.

In building up the clutch device 10, the rolling bearing 40 is fitted in the small diameter inner circumferential surface 19a from the axial side. The other first spring seat 21, second spring seat 22 and coil spring 15 are installed from the other axial side after the washer 45 and the thrust bush 46 have been inserted in advance. The washer 45 and the thrust bush 46 need to be advanced from the large diameter inner circumferential surface 19b to the small diameter inner circumferential wall to thereby be attached to the small diameter inner circumferential surface 19a. Then, the tapering surface 19c functions as a guide surface when the washer 45 and the thrust bush 46 are advanced in the way described above. Namely, according to this tapering surface 19c, the washer 45 and the thrust bush 46, both having the annular shapes, can be prevented from being inclined or caught in the process of installation of the washer 45 and the thrust bush 46.

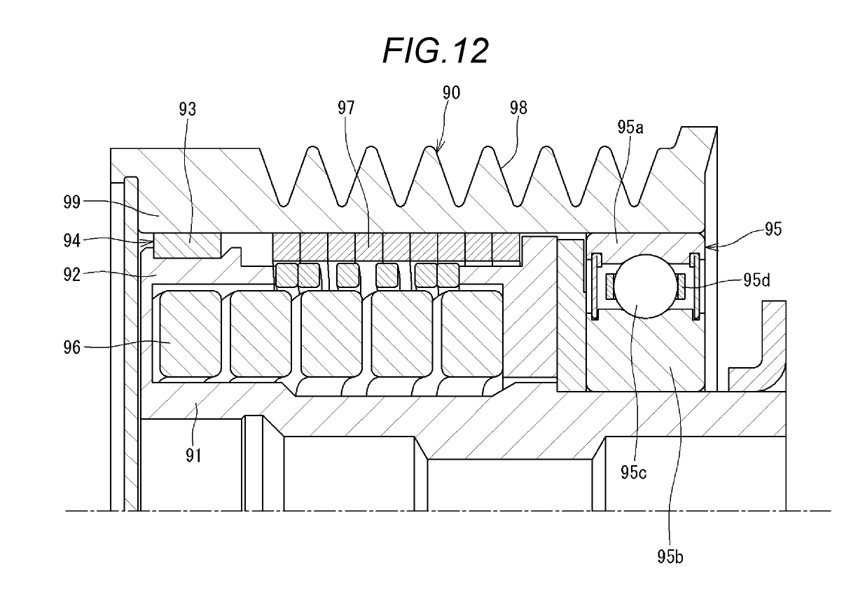

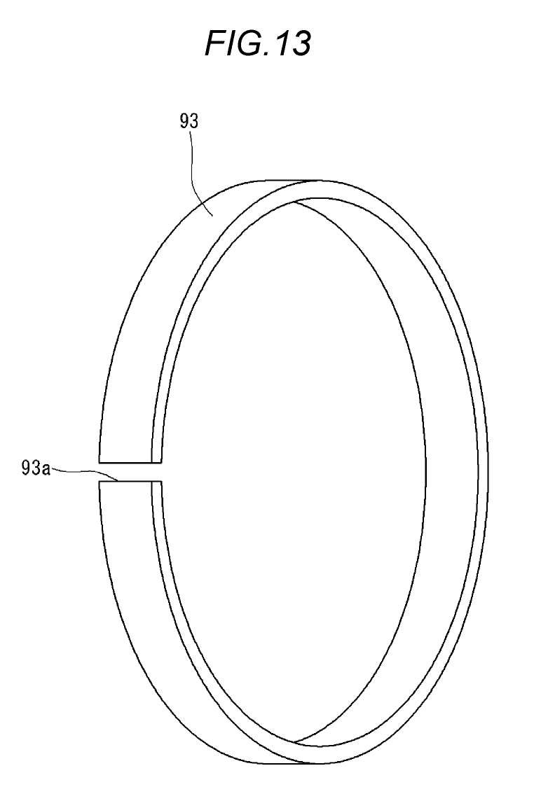

Here, the prior art (refer to FIG. 12) will be described. The bush 93 including a clutch device of the prior art technique has a ring shape as shown in FIG. 13 but is cut at one circumferential location, whereby the bush 93 has a C-shape. Grease is provided on the bush 93 to ensure a lubricating ability of the bush 93 because the bush 93 is brought into sliding contact with part of the outer member 99 on an outer circumferential surface of the bush 93. Grease is caused to adhere to the bush 93 when the clutch device 90 is built up. In addition to this, since the cut portion 93a exists in the bush 93 as described above (refer to FIG. 13), grease can be reserved in this cut portion 93a.

However, the cut portion 93a in the bush 93 is narrow. Thus, even though grease is reserved in the cut portion 93a, the grease flows out of this cut portion 93a in an axial direction, leading to fears that the grease is used up too early on a sliding contact surface of the bush 93. When the grease is used up, the bush 93 is put in a poorly lubricated state, whereby the temperature of the clutch device 90 increases abnormally to generate abnormal noise due to frictional heat.

Then, to ensure a good lubricating ability over a long period of time by grease in a slide bearing of the clutch device, the following invention (the clutch device) is disclosed.

Namely, the clutch device 10 (refer to FIG. 1) includes the shaft member 11, the outer rotor 20 provided on the radially outer side of the shaft member 11, the clutch module 30 configured to selectively switch between the free state where the shaft member 11 and the outer rotor 20 are allowed to rotate relatively and the lock state where the shaft member 11 and the outer rotor 20 are not allowed to rotate relatively, the coil spring 15 configured to absorb a rotational fluctuation between the shaft member 11 and the outer rotor 20 when the clutch module 30 is in the lock state, and the rolling bearing 40 and the slide bearing 50, the rolling bearing 40 and the slide bearing 50 being configured to support the shaft member 11 and the outer rotor 20 so as to rotate relatively when the clutch module 30 is in the free state, wherein the slide bearing 50 has, between part of the shaft member 11 and part of the outer rotor 20, the first bush module 51 provided at the axial side and the second bush module 52 provided at the other axial side while forming the grease holding space 55 between the first bush module 51 and the second bush module. The configurations described in the embodiments and their modified examples (for example, the configurations of the slide bearing 50) can be applied to this clutch device 10.

According to this clutch device 10, the space 55 is defined by the first bush module 51 and the second bush module 52 of the slide bearing 50 between the part of the shaft member 11 and the part of the outer rotor 20, whereby grease can be reserved and held in this space 55. The shaft member 11 and the outer rotor 20 are supported by the rolling bearing 40 and the slide bearing 50 in the free state where the shaft member 11 and the outer rotor 20 are allowed to rotate relatively, and the good lubricating ability can be ensured over a long period of time by grease in the space 55 in the slide bearing 50. As a result, the clutch device 10 configured in the way described above can contribute to realization of a long life of the clutch device 10.

The embodiments and their modified examples that have been disclosed heretofore are all provided to exemplify the invention in every point and are not intended to restrict the invention. Namely, the clutch device of the invention is not limited to the embodiments and their modified examples shown in the drawings but may be carried out in other forms without departing from the sprit and scope of the invention.

While the sectional shape of the first bush module 51 and the sectional shape of the second bush module 52 are described as being the same in the embodiments and their modified example, the first bush module 51 and the second bush module 52 may have different sectional shapes.

Additionally, while the rolling bearing 40 is described as being the ball bearing in the embodiments and their modified examples, the rolling bearing 40 may be a roller bearing using rollers as rolling elements. While the clutch module 30 is described as the one-way clutch having the needle rollers 32 as engaging elements, although not shown, the clutch module 30 may be a one-way clutch employing sprags as engaging elements. The clutch module 30 may be a one-way clutch, not shown, using a clutch spring in place of the one-way clutch having such engaging elements.

While the combination of the rolling bearing 40 and the slide bearing 50 is described as being the bearing configured to support the shaft member 11 and the outer rotor 20 that rotate relatively in the embodiments and their modified examples, other configurations may be adopted. The bearing at the axial side shown in FIG. 1 can be made up of a slide bearing, while the bearing at the other axial side shown in FIG. 1 can be made up of a rolling bearing.

The slide bearing 50 should have a plurality of bush modules, and a space or spaces defined by the bush modules constitute a grease holding space. Namely, the slide bearing 50 should have at least the first bush module 51 and the second bush module 52. As FIGS. 10 and 11 show, the slide bearing 50 may have further the third bush module or modules 73, and the spaces defined by the first bush module 51, the second bush module 52 and the third bush module or modules 73 may constitute a grease holding space 55.

Although the clutch device of the invention is described as being applied to the alternator, the clutch device can also be applied to other equipment.

This patent application is based on Japanese Patent Application (No. 2016-102262) filed on May 23, 2016 and Japanese Patent Application (No. 2016-188330) filed on Sep. 27, 2016, the contents of which are incorporated herein by reference.

### DESCRIPTION OF REFERENCE NUMERALS

10: Clutch device;
11: Shaft member;
12: Outer circumferential surface;
15: Coil spring;
16: one end portion;
17: The other end portion;
20: Outer rotor;
21: First spring seat;
1a: Inner circumferential surface;
22: Second spring seat;
22a: Inner circumferential surface;
23: Outer member;
30: Clutch module;
40: Rolling bearing;
50: Slide bearing;
51 First bush module;
51b: Outer circumferential surface;
52: Second bush module;
52b: Outer circumferential surface;
55: Space;
56: Convex portion;
57: Concave portion;
58: Convex portion;
59: Concave portion;
61: Cut-out portion;
62: Cut-out portion;
70: Connecting bush module;
71, 72: Pillar module;
73: Third bush module.

1. A clutch device comprising:
a shaft member;
an outer rotor provided on a radially outer side of the shaft member;
a clutch module configured to selectively switch between a free state where the shaft member and the outer rotor are allowed to rotate relatively and a lock state where the shaft member and the outer rotor are not allowed to rotate relatively;
a coil spring configured to absorb a rotational fluctuation between the shaft member and the outer rotor in the lock state; and
a bearing configured to support the shaft member and the outer rotor to rotate relatively in the free state,
wherein the clutch module is provided on the radially outer side of the shaft member, and the coil spring configured to absorb the rotational fluctuation is provided further radially outwards than the clutch module.

2. The clutch device according to claim 1, comprising a rolling bearing and a slide bearing as the bearing,
wherein the slide bearing includes, between a part of the shaft member and a part of the outer rotor, a first bush module provided at one axial side and a second bush module provided at the other axial side while forming a grease holding space between the first bush module and the second bush module.

3. The clutch device according to claim 2,
wherein the outer rotor comprises:
a first spring seat provided on the radially outer side of the shaft member via the clutch module;
a cylindrical outer member provided on a radially outer side of the first spring seat; and
a second spring seat provided away from the first spring seat in an axial direction and configured to rotate together with the outer member,
wherein the coil spring is attached to the first spring seat at one end portion of the coil spring and is attached to the second spring seat at the other end portion of the coil spring,
wherein the clutch module has a function to switch between the free state where the shaft member and the first spring seat are allowed to rotate relatively and the lock state where the shaft member and the first spring seat are not allowed to rotate relatively, and
wherein the first bush module and the second bush module are provided between an inner circumferential surface of the second spring seat and an outer circumferential surface of the shaft member.

4. The clutch device according to claim 3,
wherein the first bush module and the second bush module fit in an inner circumferential side of the second spring seat,
wherein a convex portion and a concave portion are provided between an outer circumferential surface of the first bush module and the inner circumferential surface of the second spring seat, the convex portion and the concave portion being configured to fit each other so as to prevent an axial movement of the first bush module relative to the second spring seat, and
wherein a convex portion and a concave portion provided between an outer circumferential surface of the second bush module and the inner circumferential surface of the second spring seat, the convex portion and concave portion being configured to fit each other so as to prevent an axial movement of the second bush module relative to the second spring seat.

5. The clutch device according to claim 2,
wherein a cut-out portion is provided on at least one bush module of the first bush module and the second bush module to expand the space formed between the other bush module and the at least one bush module.

6. The clutch device according to claim 2,
wherein the slide bearing further includes a connecting bush module interposed between the first bush module and the second bush module to integrate the first bush module and the second bush module.

7. The clutch device according to claim 6,
wherein the connecting bush module includes a plurality of pillar modules provided at certain intervals in a circumferential direction and configured to connect together the first bush module having an annular shape and the second bush module having an annular shape.

8. The clutch device according to claim 6,
wherein the connecting bush module includes an annular third bush module provided between the first bush module having the annular shape and the second bush module having the annular shape and a pillar module configured to connect together the bush modules disposed adjacent to each other in an axial direction.

9. A clutch device comprising:
a shaft member;
an outer rotor provided on a radially outer side of the shaft member;
a clutch module configured to selectively switch between a free state where the shaft member and the outer rotor are allowed to rotate relatively and a lock state where the shaft member and the outer rotor are not allowed to rotate relatively;
a coil spring configured to absorb a rotational fluctuation between the shaft member and the outer rotor in the lock state; and
a rolling bearing and a slide bearing configured to support the shaft member and the outer rotor to rotate relatively in the free state,
wherein the slide bearing includes, between a part of the shaft member and a part of the outer rotor, a first bush module provided at one axial side and a second bush module provided at the other axial side while forming a grease holding space between the first bush module and the second bush module.
